(19) United States
(12) Patent Application Publication
(10) Pub. No.: US 2025/0369263 A1
(43) Pub. Date: Dec. 4, 2025

(54) VEHICLE LATCH HAVING UNIDIRECTIONAL POWER RELEASE FUNCTION

(71) Applicant: MAGNA CLOSURES INC., Newmarket (CA)

(72) Inventor: Kris TOMASZEWSKI, Newmarket (CA)

(21) Appl. No.: 19/223,107

(22) Filed: May 30, 2025

Related U.S. Application Data
(60) Provisional application No. 63/654,560, filed on May 31, 2024.

(51) Int. Cl. E05B 81/06; E05B 81/34; E05B 81/42; E05B 81/50

(52) U.S. Cl. CPC E05B 81/06; E05B 81/34; E05B 81/42; E05B 81/50; E05Y 2900/531

(57) ABSTRACT

A latch assembly for a closure member of a motor vehicle, including a ratchet and pawl assembly and a power release mechanism having a power release gear movable by a motor in a single direction to actuate the ratchet and pawl assembly, with a blocking mechanism movable in response to movement of the power release gear between a blocking position, whereat rotation of power release gear is impeded, and an unblocking position, whereat rotation of the power gear is permitted.

### CROSS-REFERENCE TO RELATED APPLICATION

This application claims the benefit of U.S. Provisional Application Ser. No. 63/654,560, filed May 31, 2024, which is incorporated herein by way of reference in its entirety.

### FIELD

The present disclosure relates generally to automotive door latches, and more particularly, to a power door latch assembly equipped with a power motor providing a power release function.

### BACKGROUND

This section provides background information related to automotive door latches and is not necessarily prior art to the concepts associated with the present disclosure.

A vehicle closure panel, such as a side door for a vehicle passenger compartment, is hinged to swing between open and closed positions and includes a latch assembly mounted to the door. The latch assembly functions in a well-known manner to latch the door when it is closed and unlatch and release the door to permit subsequent movement of the door to its open position. As is also well known, the latch assembly is configured to include a latch mechanism for latching the door and a release mechanism for unlatching the door. The release mechanism can be power-operated to unlatch the door.

During powered actuation of latch mechanism, it is known to actuate a motor in a first actuation and in a first direction to actuate a first gear mechanism to move from a home position in a first direction to move a pawl from a ratchet holding position to a ratchet releasing position, thereby allowing a ratchet to move from a striker capture position to a striker releasing position, whereat the door can be moved from a closed position to an open position. Then, a second actuation of the motor in a reverse, second direction is performed to reverse the direction of movement of the first gear mechanism back to the home position, known as a reset function of the latch, occurs after the release of the ratchet by the pawl. This reset function at least requires additional motor control circuitry and latch mechanism components and complexities.

Thus, there remains a need to develop alternative arrangements for latch mechanisms for use in vehicular door latches which improves functionality, reduces complexity and cost, and improves the reset function of the latch.

### SUMMARY OF THE INVENTION

This section provides a general summary of the disclosure, and is not intended to be a comprehensive and exhaustive listing of all of its features or its full scope.

In accordance with one aspect of the disclosure, a latch assembly for a closure member of a motor vehicle is provided. The latch assembly includes, a ratchet and pawl assembly and a power release mechanism having a power release gear movable by a motor in a single direction to actuate the ratchet and pawl assembly. Latch assembly further includes a blocking mechanism movable in response to movement of the power release gear between a blocking position, whereat rotation of power release gear is impeded, and an unblocking position, whereat rotation of the power gear is permitted.

In accordance with another aspect of the disclosure, the blocking mechanism is maintained in the blocking position until a bumper on the power release gear contacts the blocking mechanism.

In accordance with another aspect of the disclosure, the blocking mechanism is automatically returned from the blocking position to the unblocking position upon the bumper urging the blocking mechanism away from the blocking position.

In accordance with another aspect of the disclosure, the blocking mechanism is biased from the blocking position toward the unblocking position by a spring.

In accordance with another aspect of the disclosure, the bumper contacting the blocking mechanism stops the rotation of the power release gear without need of complex circuitry and sensors.

In accordance with another aspect of the disclosure, the power release gear moves in the single direction under the power of the motor from a home position to actuate the ratchet and pawl assembly and continues in the single direction to the home position upon the bumper contacting the blocking mechanism and stopping the rotation of the power release gear.

In accordance with another aspect of the disclosure, a power release cam on the power release gear operably moves a pawl of the ratchet and pawl assembly from a ratchet holding position to a ratchet releasing position in advance of the bumper making contact with the blocking mechanism.

In accordance with another aspect of the disclosure, the bumper and the power release cam are on opposite sides of the power release gear.

In accordance with another aspect of the disclosure, the power release gear rotates about a power release gear axis as the blocking mechanism moves between the blocking position and the unblocking position in generally parallel relation to the power release gear axis.

In accordance with another aspect of the disclosure, the blocking mechanism translates between a pair of walls of a housing of the latch assembly in response to rotation of the power release gear about the power release gear axis.

In accordance with another aspect of the disclosure, the blocking mechanism has a lock finger arranged to snap into overhanging relation with a corner edge of one of the pair of walls to bring the blocking mechanism into a releasably locked position while in the blocking position.

In accordance with another aspect of the disclosure, the blocking mechanism is biased to move into the releasably locked position by a spring upon the lock finger moving past the corner edge.

In accordance with another aspect of the disclosure, the blocking mechanism is automatically returned from the locked position to an unlocked position upon the bumper urging the blocking mechanism against the bias imparted by the spring.

In accordance with another aspect of the disclosure, the blocking mechanism, while in the unlocked position, is automatically biased by the spring to the unblocking position.

In accordance with another aspect of the disclosure, a latch assembly for a closure member of a motor vehicle, includes a ratchet movable between a striker capture position and a striker releasing position, and a pawl movable between a ratchet holding position, whereat the ratchet is in the striker capture position, and ratchet releasing position, whereat the ratchet is movable to the striker releasing position. The latch assembly further includes a power release mechanism having a power release gear movable by a motor in a single direction. The power release gear has a power release cam on one side and a power release bumper on an opposite side. The latch assembly further includes a blocking mechanism movable between a blocking position, whereat rotation of power release gear is impeded, and an unblocking position, whereat rotation of the power gear is permitted. While the latch assembly is in a latched state, whereat the ratchet is in the striker capture position, movement of the power release gear from a home position in the single direction causes the power release cam to operably drive the pawl from the ratchet holding position to the ratchet releasing position, whereupon the ratchet moves from the striker capture position to the striker releasing position, and further causes the power release bumper to move from the unblocking position to the blocking position, whereat the rotation of power release gear in the single direction is impeded by the power release bumper, whereupon the power release gear is automatically stopped in its home position and the power release bumper is automatically moved from the blocking position to the unblocking position.

In accordance with another aspect of the disclosure, a stop lever is coupled to the blocking mechanism, wherein the stop lever is operably driven the power release cam to move the blocking mechanism between the unblocking position and the blocking position.

In accordance with another aspect of the disclosure, the power release gear rotates about a power release gear axis and the stop lever rotates about a stop lever axis, the power release gear axis extending generally transverse to the stop lever axis.

In accordance with another aspect of the disclosure, the stop lever is pivotably coupled to the blocking mechanism.

In accordance with another aspect of the disclosure, the blocking mechanism moves between the blocking position and the unblocking position in generally parallel relation to the power release gear axis in response to the stop lever rotating about a stop lever axis.

In accordance with another aspect of the disclosure, the blocking mechanism has a lock finger arranged to snap under a bias of a spring into overhanging relation with a corner edge of a wall of a housing of the latch assembly to bring the blocking mechanism into a releasably locked position while in the blocking position, whereupon the blocking mechanism is automatically returned from the releasably locked position to an unlocked position upon the power release bumper urging the blocking mechanism against the bias of the spring, whereupon the spring biases the blocking mechanism to automatically return to the unblocking position.

Accordingly, there is provided a latch assembly for a closure member of a motor vehicle, including a ratchet and a pawl assembly, a power release mechanism for moving a pawl of the ratchet and pawl assembly, the power release mechanism having a power release gear movable by a motor in a single direction, and a blocking mechanism movable as a function of a power release operation between a blocking position whereat the rotation of power release gear is prevented and an unblocking position whereat the rotation of the power gear is permitted.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings, wherein:

FIG. 1 is a partial perspective view of a motor vehicle having a side door equipped with a power latch assembly embodying the teachings of the present disclosure;

FIG. 2 is a side view of a ratchet and pawl assembly of the latch assembly of FIG. 1;

FIG. 3 is a partial perspective view of the latch assembly of FIG. 1 illustrating various components of a power release kinematic chain including a power release gear of the power release kinematic chain configured to be driven in a single direction by a motor of the power release kinematic chain;

FIG. 4A is a partial perspective view of the of the latch assembly of FIG. 3, showing the beginning of a power release operation;

FIG. 4B is a partial side view of the of the latch assembly of FIG. 1, showing a blocking mechanism in a non-blocking position when the latch is at the beginning of the power release operation as shown in FIG. 4A;

FIG. 5A is a partial perspective view of the of the latch assembly of FIG. 3, showing the continuation of the power release operation;

FIG. 5B is a partial perspective view of the of the blocking mechanism of latch assembly of FIG. 3, during the continuation of a power release operation with a slider being moved by a stop lever toward a releasably locked, blocking position;

FIG. 5C is a partial side view of the of the latch assembly of FIG. 5B, showing the blocking mechanism being moved toward the releasably locked, blocking position during the power release operation;

FIG. 6A is a view similar to FIG. 5A, showing the further continuation of a power release operation with a power release cam fixed to the power release gear in a bypassed relation with power release lever, with a release lever being automatically return to a home position via a biasing member;

FIG. 6B is a view similar to FIG. 5B, showing the further continuation of a power release operation with the slider moved into the releasably locked, blocking position;

FIG. 6C is a partial side view of the of the latch assembly of FIG. 6B, showing the blocking mechanism having moved into the releasably locked, blocking position during the power release operation;

FIG. 7A is a partial perspective view of the of the latch assembly of FIG. 3, illustrating a cessation of the power release operation;

FIG. 7B is a view similar to FIG. 6B, during the cessation of a power release operation with the slider being moved from the releasably locked, blocking position toward the non-blocking position;

FIG. 7C is a partial side view of the of the latch assembly of FIG. 7B, showing the blocking mechanism having moved from the releasably locked, blocking position toward the non-blocking position;

FIG. 8A is a partial perspective view of the of the latch assembly of FIG. 3, showing an end of the power release operation;

FIG. 8B is a view similar to FIG. 7B, during the end of the power release operation with the slider being moved back to the non-blocking position; and

FIG. 8C is a partial side view of the of the latch assembly of FIG. 8B, showing the blocking mechanism having moved into the non-blocking position after the motor has been deactivated and the power release gear motion has been stopped.

### DETAILED DESCRIPTION OF EXAMPLE EMBODIMENTS

One or more example embodiments of a powered latch assembly of the type well-suited for use in motor vehicle closure systems will now be described with reference to the accompany drawings. However, these example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by a skilled artisan.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

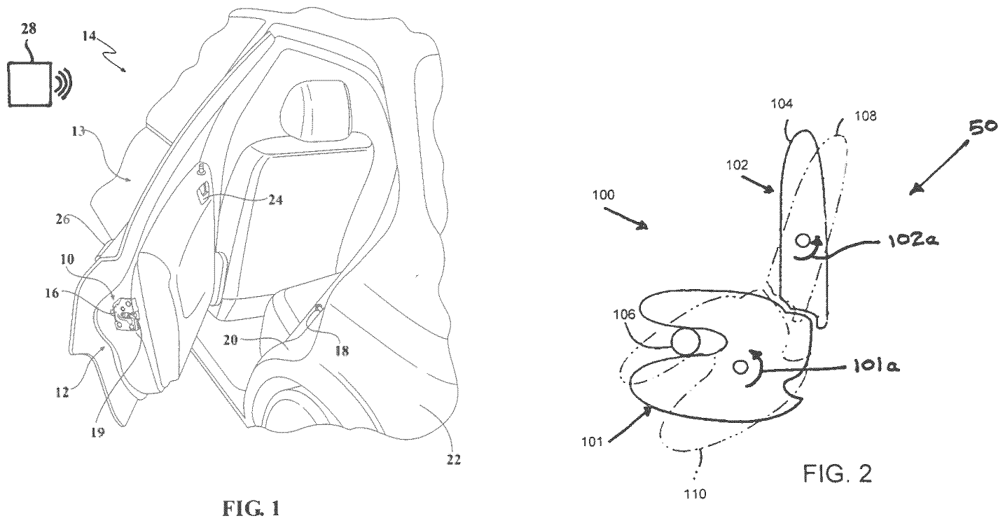

Referring initially to FIG. 1, a non-limiting example of a power latch assembly is shown, referred to hereafter simply as latch assembly 10, installed in a closure panel, such as, by way of example and without limitation, a door, shown as a passenger side swing door 12 of a motor vehicle 14. Latch assembly 10 includes a latch mechanism 16 configured to releasably latch and hold a striker 18 mounted to a sill portion 20 of a vehicle body 22 when swing door 12 is closed. Latch assembly 10 can be selectively actuated via mechanical actuation of an inside release mechanism, such as an inside door handle 24, an outside release mechanism, such as an outside door handle 26 and/or a key fob 28 (FIG. 2). As will be detailed, latch assembly 10 is configured to be power-operated to perform multiple functions, including, by way of example and without limitation, effecting a power release, effecting an inside double pull release (via a double pull of the inside release mechanism 24), and placing the latch assembly 10 in a power child lock position, via selective actuation of a single power release actuator, such as an electric motor, also referred to simply as motor 111. By multiple functions being powered via the single power release actuator 111, the latch assembly 10 is able to be manufactured in economical fashion, while also being minimized in size and weight, thereby enhancing the flexibility of design of the closure panel, while also reducing the cost associated therewith.

As shown in FIG. 2, latch assembly 10 has a latch mechanism 50 including a ratchet and pawl assembly 100, including a ratchet 101 and a pawl 102. Pawl 102 is movable between a primary ratchet holding position 104, whereat ratchet 101 is held by pawl 102 in a primary striker capture position to maintain a striker 106 in a primary closed position, to a ratchet releasing position 108 to allow the ratchet 101 to rotate under a bias imparted by a ratchet biasing member 101a, such as ratchet torsion spring, to a striker releasing position 110 to allow the striker 106 to be released from the ratchet 100 and allow the door 12 to move to an open position. Pawl 101 is biased toward the primary ratchet holding position 104 by a pawl biasing member 102a, such as torsion spring, such that the bias imparted by the pawl biasing member 102a is overcome by a release mechanism, discussed further below, during movement of the pawl 101 from the primary ratchet holding position 104 to the ratchet releasing position 108.

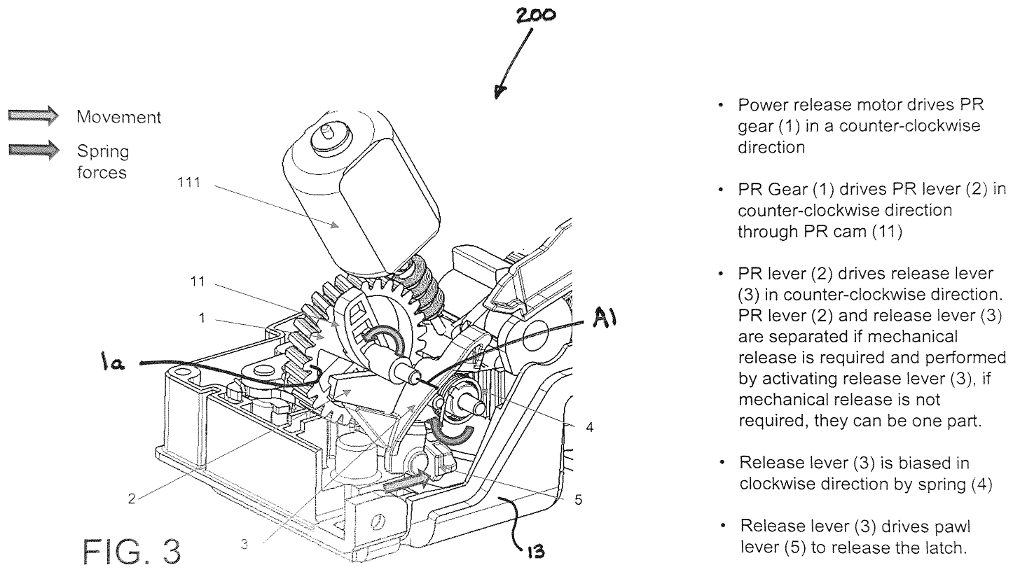

Now referring to FIG. 3, there is shown a power release mechanism 200 arranged for moving the pawl 102 from the primary ratchet holding position 104 against the bias imparted by the pawl biasing member 102a to the ratchet releasing position 108. Illustratively, a pawl lever 5 is arranged for operative communication with pawl 102 (FIG. 2), either for direct engagement with pawl 102 or indirectly via an intervening lever, as will be readily understood by a person possessing ordinary skill in the art, during rotation of a power release gear 1. Latch assembly 10 is configured having a unidirectional power release function, such that power release gear 1 of power release mechanism 200 is driven rotatably by motor 111 in a single direction from a home position about a power release gear support axis A1, shown as being in a counter-clockwise direction in FIGS. 3, 5A, 6A, and 7A, without requiring motor 111 or power release gear 1 to be driven in an opposite, clockwise direction for resetting the power release gear 1 of latch assembly 10 back to the home position after a power release operation has been performed. Accordingly, as discussed further below, latch mechanism 50 is operable to perform a power release operation and a reset operation via powered movement of motor 111 and power release gear 1 in a single direction, and thus, reverse operation of motor 111 in the release and reset operation is not required.

With continued reference to FIG. 3, during driven rotation of power release gear 1 by motor 111, a power release cam 11, fixed to a first side 1a of power release gear 1, is driven for forcible engagement with a power release lever 2, thereby driving power release lever 2 in the counter-clockwise direction, as viewed in FIG. 3, to bring power release lever 2 into driving engagement with a release lever 3, whereupon release lever 3 is driven in the counter-clockwise direction, as viewed in FIG. 3, against a bias imparted by a release lever biasing member 4, such as a spring, to bring release lever 3 into driving engagement with the pawl lever 5. The driving engagement of release lever 3 with pawl lever 5 causes pawl lever 5 to be driven in the counter-clockwise direction, as viewed in FIG. 3, thereby driving pawl lever 5 into driving engagement, directly or indirectly, with pawl 102 to move pawl 102 from its primary ratchet holding position 104 to its ratchet releasing position 108. Accordingly, as discussed above, rotation of power release gear 1 from the home position, in a single direction, operably drives pawl lever 5 to move pawl 102 from its primary ratchet holding position 104 to its ratchet releasing position 108.

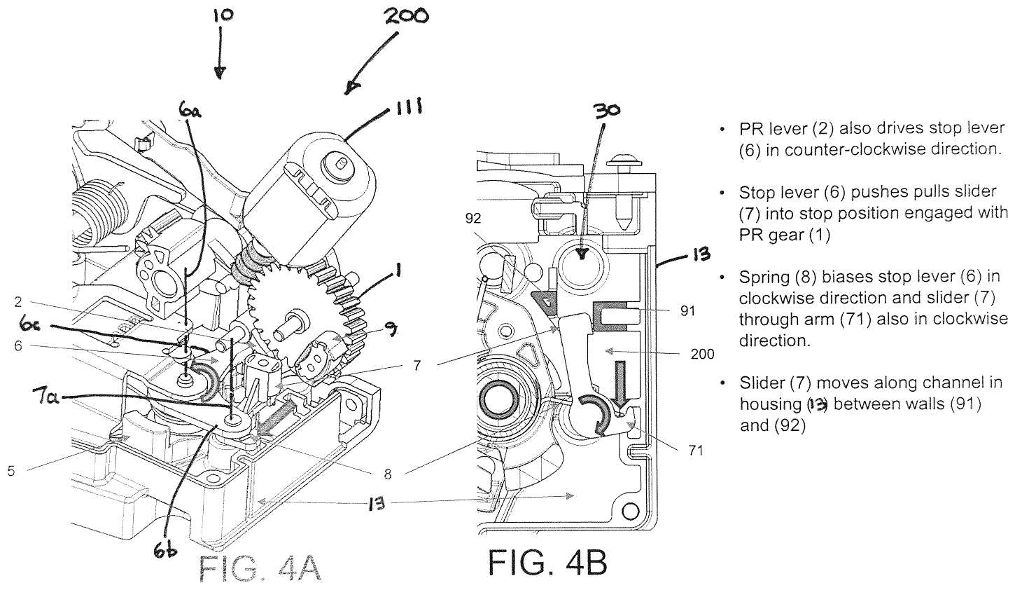

Now referring to FIGS. 4A and 4B, the power release mechanism 200 includes a blocking mechanism, also referred to and shown illustratively as a slider 7, that can be moved in sliding, translating relation into the path of rotation of the power release gear 1, to a releasably locked, blocking position, to block rotation of the power release gear 1, and out of the path of rotation of the power release gear 1, to a non-blocking, also referred to as unblocking position, to allow rotation of the power release gear 1. Illustratively, blocking member 7 is a cantilevered link that is operatively coupled to the power release gear 1 via a pivotal coupled attachment, such as via a pin extending along a pivotal pin axis 7a, to stop lever 6. Stop lever 6 is shown as being generally L-shaped, with one leg 6b extending to an end that is pivotably coupled to blocking member 7 via the pin defining pivotal pin axis 7a, and another leg 6c extending to an opposite end that is arranged for operable driven engagement with the release lever 3, which is driven by power release lever 2, in response to the rotation of the power release gear 1 in the unidirectional releasing direction.

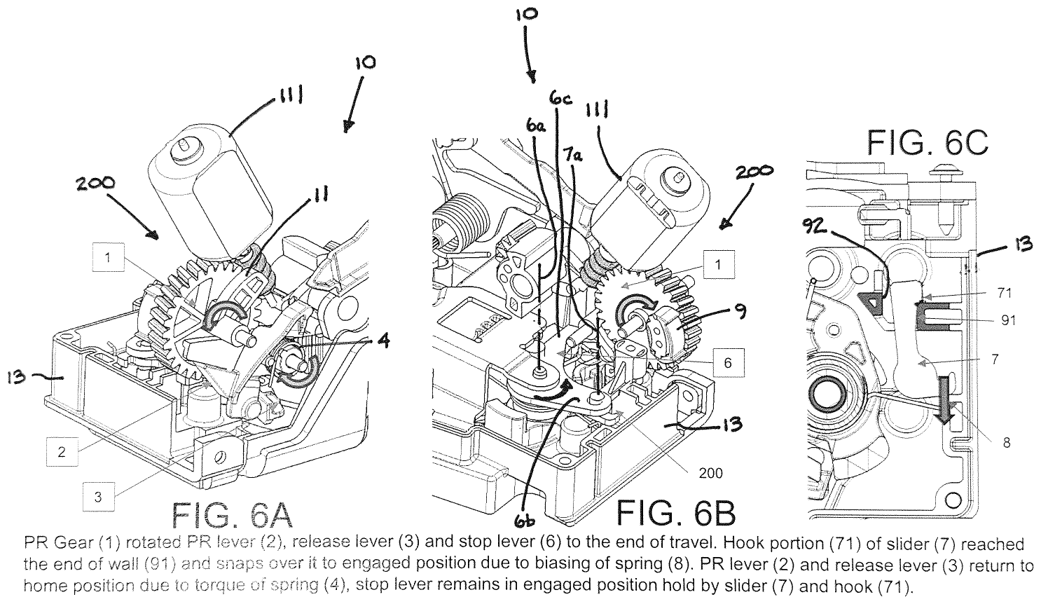

During the power release function, actuation of motor 111 causes rotation of power release gear 1 from its starting position, also referred to as home position, in FIG. 3, which rotates power release cam 11 conjointly into driving engagement with power release lever 2, thereby rotatably driving power release lever 2 into driving engagement with release lever 3, which rotates against the bias imparted by spring 4 to rotatably drive pawl lever 5 into forcible driving relation with pawl 102 to move pawl 102 from the ratchet holding position to the ratchet releasing position. Upon pawl 102 being sufficiently driven to it ratchet releasing position, power release cam 11 is rotated passed and out from engagement with the power release lever 2, whereupon the biased imparted by power release lever 2 on release lever 3 is released, and thus, release lever biasing member 4 biases release lever and power release lever 2 back to their respective, unactuated home positions. In addition to causing pawl 102 to move to the ratchet releasing position, during rotation of the power release gear 1, the driving movement of release lever 3, via driven engagement with power release lever 2, acts to drive the end of leg 6c and rotate the stop lever 6 about a stop lever axis 6a, which extends generally parallel with pivotal pin axis 7a and generally transversely to the power release gear axis A1, with generally, in both cases, intended to mean within +/−5 degrees. The rotation of stop lever 6 in a counter-clockwise direction, as illustrated in FIG. 6B, causes the end of leg 6b, pivotably coupled to slider 7, to drive slider 7 against a bias imparted by a spring 8 on slider 7 to move slider 7 in translation. The driven translation of slider 7 is in generally parallel (intended to mean truly parallel or slight off parallel, such as +/−5 degrees) relation with power release gear axis A1 within a channel 30, also referred to as opening, defined between opposing internal walls 91, 92 of the housing 13, from a non-blocking position shown in FIG. 4B into the releasably locked, blocking position shown in FIG. 6C.

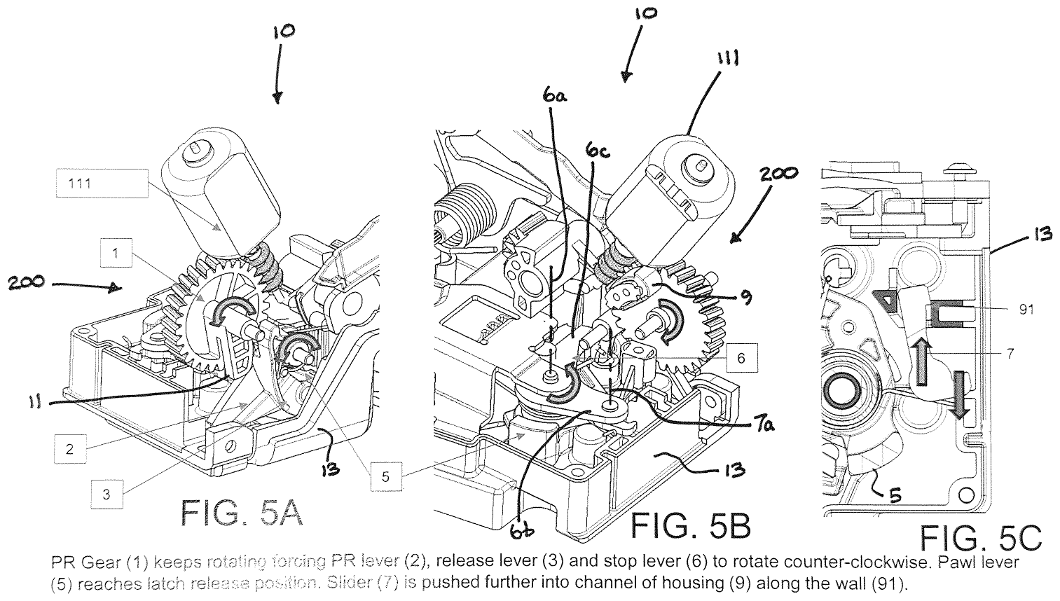

In the blocking position shown in FIG. 6C, the slider 7 has also moved from a non-deployed position, also referred to as home position, non-locked position or unlocked position (FIG. 5C), to a deployed position, also referred to as locked position (FIG. 6C), where slider 7 is releasably prevented from returning to the non-blocking position absent the power release gear 1 driving and urging the slider 7 away from the locked position back to the unlocked position. The slider 7 has a hook portion, also referred to as lock finger 71, that, upon the slider 7 being translated upwardly through the channel 30, as viewed in FIGS. 5C and 6C, snaps in overhanging relation with a corner edge, also referred to as shoulder, of wall 91 under a torsion bias imparted by spring 8 such that slider 7 is temporarily releasably locked and prevented from returning to the home position under the bias imparted by spring 8 (FIG. 6C). Upon slider 7 being moved to the releasably locked, blocking position, the power release cam 11, as discussed above, is moved beyond out of engagement from power release lever 2, thereby allowing power release lever 2 and release lever 3 to be returned to their home positions under the bias imparted by release lever biasing member 4.

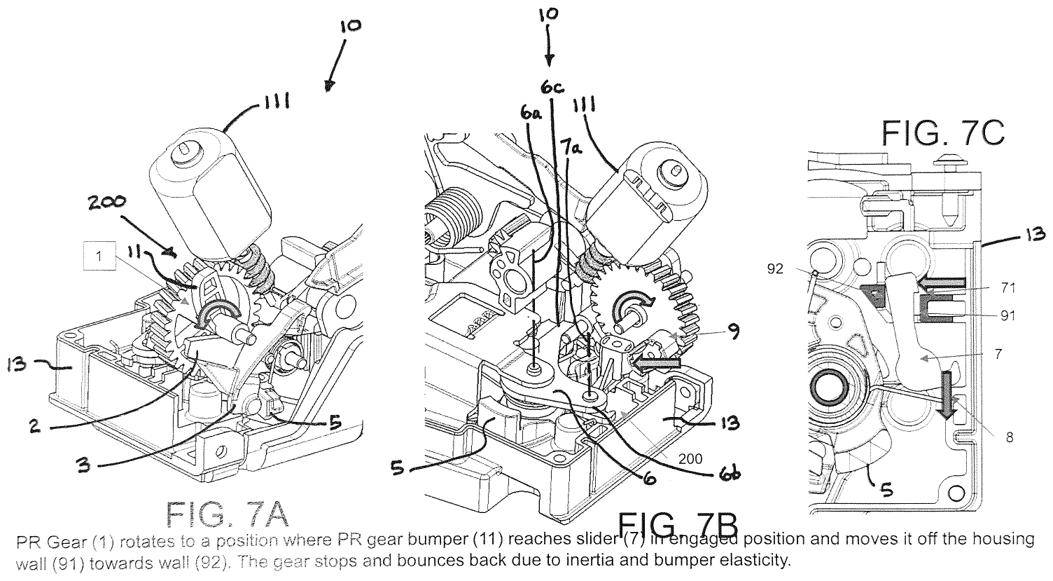

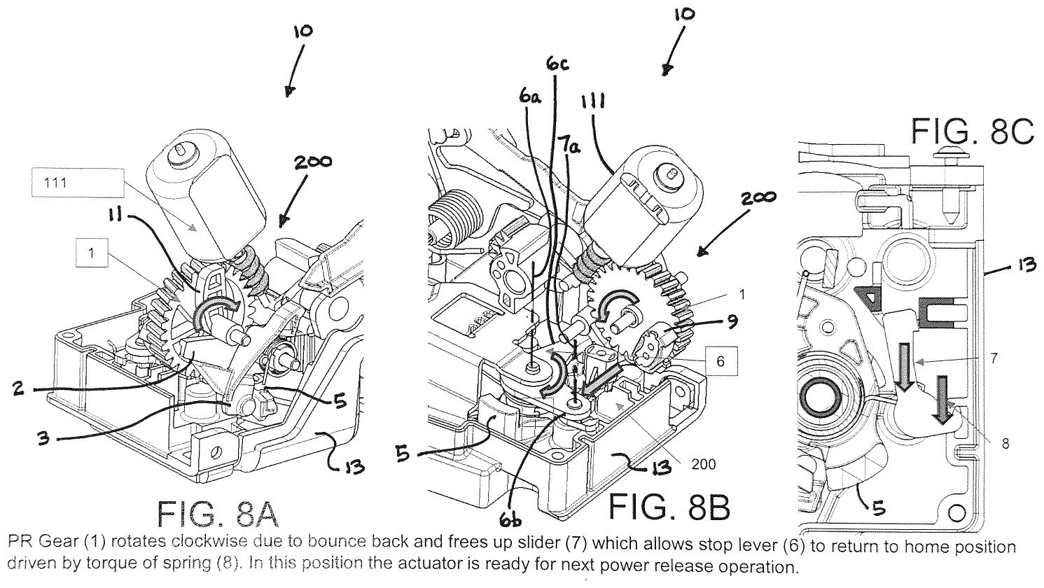

Now referring to FIG. 7C, after the power release function has been completed, whereupon the pawl 102 has been released from the ratchet holding position to the ratchet releasing position, the rotation of the power release gear 1 continues, as shown in FIGS. 7A and 7B, whereupon a power release gear bumper 9, such as an elastomeric bumper, fixed to power release gear 1 on an opposite side of power release gear 1 from power release cam 11, engages lock finger 71 of the slider 7 located within the rotational path of the power release gear 1. Upon engagement with the lock finger 71, prior to the power release gear 1 being stopped, the power release gear bumper 9 urges the lock finger 71 against the bias of spring 8 and moves lock finger 71 out from locked, overhanging engagement with the shoulder of wall 91, thereby moving slider 7 away from its releasably locked position to its released, unlocked position as shown in FIG. 7C. As a result, the slider 7 is urged under the bias of spring 8 back downwardly, as viewed in FIG. 7C, through the channel 30 to its non-locked, unblocking position as shown in FIG. 8C. At this point in the sequence, upon the power release gear 1 engaging and urging the lock finger 71 to its unlocked position, the rotation of power release gear 1 is impeded and stopped back in a position corresponding to its initial home position without need of a position sensor or control mechanism, and without being moved via reversal of the motor 111 in an opposite resetting direction. The power release gear 1 remains in this stopped, home position until a further power release activation of motor 111, whereupon, the power release gear 1 will be rotated from its home position in the same, single direction as the previous rotation of the power release gear 1 discussed above and shown in FIGS. 3 through 7B, whereupon the same process discussed above is repeated. As such, the motor 111 and power release gear 1 only rotate in a single direction, with power release gear 1 rotating from its home position, 360 degrees, back to its home position, without having to reverse direction, in a combined latch release and reset operation. Accordingly, the power latch assembly 10 obviates the use of complex reversing direction controls, sensors, mechanisms, and reset spring for power release gear 1.

The present disclosure therefore, as discussed above and illustrated, provides a latch assembly 10 that allows for a minimally sized power release motor 111 to be utilized since a spring to reset the power release gear 1 is not used, which would otherwise increase the required energy and torque output of the motor since the spring would require being wound and/or bias overcome during a power release operation using part of the motor torque and energy output therefor. The latch assembly 10 herein further provides for the elimination of a source of noise generation by doing away with a need for reversal of the motor 11 and a need for reversal of power release gear 1, as well as a need for a resetting spring, all of which would present a source for noise generation. Further yet, the latch assembly 10 disclosed herein does not require additional motor control circuitry to reverse the direction of operation of the motor 111, or require sensors for detecting a home position of the power release gear 1, thereby reducing and minimizing the size, complexity, and cost of latch assembly 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A latch assembly for a closure member of a motor vehicle, comprising:
a ratchet and pawl assembly;
a power release mechanism having a power release gear movable by a motor in a single direction to actuate the ratchet and pawl assembly; and
a blocking mechanism movable in response to movement of the power release gear between a blocking position, whereat rotation of power release gear is impeded, and an unblocking position, whereat rotation of the power gear is permitted.

2. The latch assembly of claim 1, wherein the blocking mechanism is maintained in the blocking position until a bumper on the power release gear contacts the blocking mechanism.

3. The latch assembly of claim 2, wherein the blocking mechanism is automatically returned from the blocking position to the unblocking position upon the bumper urging the blocking mechanism away from the blocking position.

4. The latch assembly of claim 3, wherein the blocking mechanism is biased from the blocking position toward the unblocking position by a spring.

5. The latch assembly of claim 2, wherein the bumper contacting the blocking mechanism stops the rotation of the power release gear.

6. The latch assembly of claim 5, wherein the power release gear moves in the single direction under the power of the motor from a home position to actuate the ratchet and pawl assembly and back to the home position upon the bumper contacting the blocking mechanism and stopping the rotation of the power release gear.

7. The latch assembly of claim 2, wherein a power release cam on the power release gear operably moves a pawl of the ratchet and pawl assembly from a ratchet holding position to a ratchet releasing position in advance of the bumper making contact with the blocking mechanism.

8. The latch assembly of claim 7, wherein the bumper and the power release cam are on opposite sides of the power release gear.

9. The latch assembly of claim 8, wherein the power release gear rotates about a power release gear axis as the blocking mechanism moves between the blocking position and the unblocking position in generally parallel relation to the power release gear axis.

10. The latch assembly of claim 9, wherein the blocking mechanism translates between a pair of walls of a housing of the latch assembly in response to rotation of the power release gear about the power release gear axis.

11. The latch assembly of claim 10, wherein the blocking mechanism has a lock finger arranged to snap into overhanging relation with a corner edge of one of the pair of walls to bring the blocking mechanism an unlocked position into a releasably locked position while in the blocking position.

12. The latch assembly of claim 11, wherein the blocking mechanism is biased into the releasably locked position by a spring.

13. The latch assembly of claim 12, wherein the blocking mechanism is automatically returned from the blocking position to an unblocking position upon the bumper urging the blocking mechanism against the bias imparted by the spring.

14. The latch assembly of claim 13, wherein the blocking mechanism, while in the unlocked position, is automatically biased by the spring to the unblocking position.

15. A latch assembly for a closure member of a motor vehicle, comprising:
a ratchet movable between a striker capture position and a striker releasing position;
a pawl movable between a ratchet holding position, whereat the ratchet is in the striker capture position, and ratchet releasing position, whereat the ratchet is movable to the striker releasing position;
a power release mechanism having a power release gear movable by a motor in a single direction, the power release gear having a power release cam on one side and a power release bumper on an opposite side; and
a blocking mechanism movable between a blocking position, whereat rotation of power release gear is impeded, and an unblocking position, whereat rotation of the power gear is permitted,
wherein, while the latch assembly is in a latched state, whereat the ratchet is in the striker capture position, movement of the power release gear from a home position in the single direction causes the power release cam to operably drive the pawl from the ratchet holding position to the ratchet releasing position, whereupon the ratchet moves from the striker capture position to the striker releasing position, and further causes the power release bumper to move from the unblocking position to the blocking position, whereat the rotation of power release gear in the single direction is impeded by the power release bumper, whereupon the power release gear is stopped in its home position and the power release bumper is moved from the blocking position to the unblocking position.

16. The latch assembly of claim 15, further including a stop lever coupled to the blocking mechanism, wherein the stop lever is operably driven the power release cam to move the blocking mechanism between the unblocking position and the blocking position.

17. The latch assembly of claim 16, wherein the power release gear rotates about a power release gear axis and the stop lever rotates about a stop lever axis, the power release gear axis extending generally transverse to the stop lever axis.

18. The latch assembly of claim 17, wherein the stop lever is pivotably coupled to the blocking mechanism.

19. The latch assembly of claim 18, wherein the blocking mechanism moves between the blocking position and the unblocking position in generally parallel relation to the power release gear axis in response to the stop lever rotating about a stop lever axis.

20. The latch assembly of claim 19, wherein the blocking mechanism has a lock finger arranged to snap under a bias of a spring into overhanging relation with a corner edge of a wall of a housing of the latch assembly to bring the blocking mechanism into a releasably locked position while in the blocking position, whereupon the blocking mechanism is automatically returned from the releasably locked position to an unlocked position upon the power release bumper urging the blocking mechanism against the bias of the spring, whereupon the spring biases the blocking mechanism to the unblocking position.
